(19) United States
(12) Patent Application Publication
(10) Pub. No.: US 2006/0153363 A1
(43) Pub. Date: Jul. 13, 2006

(54) PLASMA DISPLAY APPARATUS

(75) Inventor: Byung Joon Rhee, Yongin-si (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,502

(22) Filed: Jan. 10, 2006

(30) Foreign Application Priority Data
Jan. 10, 2005 (KR) 10-2005-0002352
Jan. 10, 2005 (KR) 10-2005-0002354

(51) Int. Cl. H04L 9/06

(52) U.S. Cl. 380/29

(57) ABSTRACT

This document relates to a plasma display apparatus, and more particularly, to a plasma display apparatus that drives electrodes. A plasma display apparatus according to an embodiment of the present invention comprises a plasma display panel comprising a scan electrode and a sustain electrode, a driver for driving the scan electrode and the sustain electrode, and a sustain pulse controller for controlling the driver so that a first sustain pulse applied to the scan electrode and a second sustain pulse applied to the sustain electrode are overlapped with each other, at least one of the first sustain pulse applied to the scan electrode and the second sustain pulse applied to the sustain electrode has a falling (ER-Up) period and a rising (ER-Up) period that are different from each other, and the falling (ER-Down) period at the overlapped point of the sustain pulses is adjusted depending on the magnitude of a noise generated in a falling direction of the sustain pulse.

### CROSS-REFERENCES TO RELATED APPLICATIONS

This Nonprovisional application claims priority under 35 U.S.C. § 119(a) on Patent Application No. 10-2005-0002352 and No. 10-2005-0002354 filed in Korea on Jan. 10, 2005, the entire contents of which are hereby incorporated by reference.

### BACKGROUND OF THE INVENTION

1. Field of the Invention

This document relates to a plasma display apparatus, and more particularly, to a plasma display apparatus that drives electrodes.

2. Background of the Related Art

In general, a plasma display apparatus among display apparatuses comprises a plasma display panel and a driver for driving the plasma display panel.

The plasma display panel comprises a front substrate and a rear substrate. Barrier ribs formed between the front substrate and the rear substrate forms one unit cell. Each cell is filled with an inert gas containing a primary discharge gas, such as neon (Ne), helium (He) or a mixed gas (Ne+He) of neon (Ne) and helium (He), and a small amount of xenon (Xe). When the inert gas is discharged with a high frequency voltage, it generates vacuum ultraviolet rays. Phosphors formed between the barrier ribs are excited to implement images. The plasma display panel can be made thin and light, and has thus been in the spotlight as the next-generation display devices.

Such a plasma display panel is driven with each sub-field of one frame being divided into a reset period for initializing all the cells, an address period for selecting cells to be discharged, a sustain period for sustaining the discharge of selected cells and an erase period for erasing wall charges formed within discharged cells.

In the conventional plasma display panel driven as described above, if a discharge occurs locally on the display surface of the panel, a problem arises in that an afterimage, e.g., a bright afterimage is usually generated.

FIG. 1 is a view illustrating afterimages generated in a conventional plasma display apparatus.

As shown in FIG. 1, in the case where a predetermined window pattern is displayed at a central portion of the screen, the window pattern concentrically generates a discharge at a portion 400a of a panel display surface 400. If the discharge occurs on the entire panel 400b, the window pattern that had been displayed at the portion 400a of the panel display surface 400 appears as an afterimage 400c. This afterimage 400c can be generated because of several causes, but is eventually generated due to instable emission efficiency of phosphors when a cell of the panel display surface is discharged.

Specifically, recently, the xenon (Xe) content within the discharge cell is increased so as to improve characteristics of discharge efficiency. Such an increase in the xenon (Xe) content within the discharge cell further generates a bright afterimage phenomenon as described above. The correlation between the xenon (Xe) content within the discharge cell and a discharge type within the discharge cell will be described below with reference to FIG. 2.

FIG. 2 is a view illustrating a discharge phenomenon appearing as an amount of xeon (Xe) injected into the conventional plasma display apparatus increases.

As shown in FIG. 2, a discharge within a discharge cell in which the xenon (Xe) content is high is attracted toward an address electrode 113.

For example, if the sustain voltage (Vs) is applied to the scan electrode 102 with a voltage of a ground level being applied to the address electrode 113 and the sustain electrode 103, a sustain discharge by the scan electrode 102 occurs.

Unlike the above example, if the sustain voltage (Vs) is applied to the sustain electrode 103 with a voltage of a ground level being applied to the address electrode 113 and the scan electrode 102, a sustain discharge by the sustain electrode 103 occurs.

Such a sustain discharge is dependent upon a surface discharge generated between the scan electrode 102 and the sustain electrode 103. As an amount of xenon (Xe) within the plasma display panel increases, however, an electric field between the scan electrode 102 and the sustain electrode 103 is distributed through strong interaction with the address electrode 113 during the surface discharge between the scan electrode 102 and the sustain electrode 103. As a result, a discharge within the discharge cell is further attracted toward the address electrode 113. That is, the higher the xenon (Xe) content within the discharge cell becomes, the more the discharge within the discharge cell is attracted toward the address electrode 113.

The more a discharge within the discharge cell is attracted toward the address electrode 113 as described above, the more the lower phosphor of the phosphors of the plasma display panel is degraded. As a result, the lifespan of the plasma display panel is shortened and a bright afterimage is further generated.

In this case, the above-described phosphor is in a very unstable state at an initial stage when the plasma display panel is manufactured. To stabilize the unstable state of the phosphor, aging is performed when fabricating the plasma display panel. The aging process on the phosphor will be described below with reference to FIG. 3.

FIG. 3 is a view illustrating aging performed in order to stabilize phosphors of a plasma display apparatus.

As shown in FIG. 3, when aging is carried out in order to stabilize phosphors of the plasma display panel, among phosphors 114 of the plasma display panel, a sidewall phosphor 114a formed on a lateral wall of a barrier rib 112 is relatively further degraded as compared to a lower phosphor 114b. Therefore, the sidewall phosphor 114a is more stabilized than the lower phosphor 114b.

As a result, upon the aging of the plasma display panel, an absolute luminance of the sidewall phosphor 114a is significantly lowered than that of the lower phosphor 114b. Therefore, a discharge jitter width of the sidewall phosphor 114a becomes lessthan that of the lower phosphor 114b. Such a discharge jitter will be described below with reference to FIG. 4.

FIG. 4 is a view illustrating discharge jitter in phosphors of a plasma display apparatus.

As shown in FIG. 4, a lower phosphor of phosphors of a plasma display panel has a discharge jitter width, which is relatively larger than that of sidewall phosphors. That is, a time taken to return to a stable state after the lower phosphor has been discharged is relatively longer than that of the sidewall phosphors.

Therefore, as described above, an amount of xenon (Xe) is increased or only a strong discharge occurs repeatedly between the scan electrode and the sustain electrode in the sustain period. For this reason, if a surface discharge that occurs between the scan electrode and the sustain electrode within the discharge cell is attracted toward the address electrode, the lower phosphor that has been relatively less degraded upon the aging of the plasma display panel is degraded. This results in a reduced lifespan of the plasma display panel.

Furthermore, the lower phosphor whose a return time taken to return to a stable state after a discharge is relatively long emits light. Therefore, a bright afterimage is generated on the display surface of the plasma display panel.

The problem of such a bright afterimage can be solved by lengthening a rising (ER-Up) time of the first sustain pulse applied to the scan electrode and the sustain electrode during the surface discharge. The term “ER_Up time” (Energy Recovery Time) refers to a time taken until the sustain pulse rises from 0V to the sustain voltage (Vs). If the rising (ER-Up) time is lengthened, the attraction of a discharge toward the address electrode during the surface discharge can be reduced. This may lead to a reduced bright afterimage.

If the ER_Up time of the sustain pulse is set to be long, an afterimage appearing on the screen can be improved. However, problems arise in that a load effect and an erroneous discharge occurrence ratio at high temperature abruptly rise and margin is also reduced.

### SUMMARY OF THE INVENTION

Accordingly, an object of an embodiment of the present invention is to solve at least the problems and disadvantages of the background art.

It is an object of an embodiment of the present invention to reduce generation of a bright afterimage by improving the sustain pulse of the sustain period.

It is another object of an embodiment of the present invention to prevent a degradation of a sustain margin by improving the sustain pulse of the sustain period.

It is another object of an embodiment of the present invention to prevent an electrical damage of the plasma display panel due to a noise by improving the sustain pulse of the sustain period.

To achieve the above objects, a plasma display apparatus according to an embodiment of the present invention a plasma display panel comprising a scan electrode and a sustain electrode, a driver for driving the scan electrode and the sustain electrode, and a sustain pulse controller for controlling the driver so that a first sustain pulse applied to the scan electrode and a second sustain pulse applied to the sustain electrode are overlapped with each other, at least one of the first sustain pulse applied to the scan electrode and the second sustain pulse applied to the sustain electrode has a falling (ER-Down) period and a rising (ER-Up) period that are different from each other, and the falling (ER-Down) period at the overlapped point of the sustain pulses is adjusted depending on the magnitude of a noise generated in a falling direction of the sustain pulse.

A plasma display apparatus according to another embodiment of the present invention a plasma display panel comprising a scan electrode and a sustain electrode, a driver for driving the scan electrode and the sustain electrode, and a sustain pulse controller for controlling the driver so that a first sustain pulse applied to the scan electrode and a second sustain pulse applied to the sustain electrode are overlapped with each other, and a falling (ER-Down) period at the overlapped point of the sustain pulses is adjusted to exceed a critical time length.

A plasma display apparatus according to further another embodiment of the present invention a plasma display panel comprising a scan electrode and a sustain electrode, a driver for driving the scan electrode and the sustain electrode, and a sustain pulse controller for controlling the driver so that a first sustain pulse applied to the scan electrode and a second sustain pulse applied to the sustain electrode are overlapped with each other, and a falling (ER-Down) period running to the overlapped point of the sustain pulses is more than or equal to a falling (ER-Down) period running from the overlapped point of the sustain pulses.

The present invention has advantages in that it improves the sustain pulse of the sustain period so that generation of a bright afterimage can be reduced, and a degradation of a sustain margin and an electrical damage of the plasma display panel due to a noise are prevented.

### BRIEF DESCRIPTION OF THE DRAWINGS

The embodiment of the invention will be described in detail with reference to the following drawings in which like numerals refer to like elements.

FIG. 1 is a view illustrating afterimages generated in a conventional plasma display apparatus;

FIG. 2 is a view illustrating a discharge phenomenon appearing as an amount of xenon injected into the conventional plasma display apparatus increases;

FIG. 3 is a view illustrating aging performed in order to stabilize phosphors of a plasma display apparatus;

FIG. 4 is a view illustrating discharge jitter in phosphors of a plasma display apparatus;

FIG. 5 is a view illustrating the construction of a plasma display apparatus according to an embodiment of the present invention;

FIG. 6 is a view illustrating an example of a driving waveform according to a method of driving a plasma display apparatus according to an embodiment of the present invention;

FIG. 7 shows a sustain pulse of a sustain period in the driving waveform according to the method of driving the plasma display apparatus according to an embodiment of the present invention;

FIG. 8 is a view illustrating, in more detail, a portion where sustain pulses of a scan electrode and a sustain electrode are overlapped with each other;

FIG. 9 is a view illustrating, in more detail, a portion where sustain pulses of a scan electrode and a sustain electrode are overlapped with each other;

FIG. 10 is a view illustrating a noise generated in the scan electrode or the sustain electrode at the overlapped point of the sustain pulses applied to the scan electrode and the sustain electrode;

FIG. 11 is a view illustrating a noise increasing as a falling (ER-Down) period of the sustain pulse is shortened at the overlapped point of the sustain pulses applied to the scan electrode and the sustain electrode;

FIG. 12 is a view illustrating an example of determination of a falling (ER-Down) period or a rising (ER-Up) period of the first sustain pulse applied to the scan electrode or the sustain electrode;

FIG. 13 shows a sustain pulse of a sustain period in the driving waveform according to a method of driving the plasma display apparatus according to another embodiment of the present invention;

FIG. 14 is a view illustrating, in more detail, a portion where sustain pulses of a scan electrode and a sustain electrode are overlapped with each other;

FIG. 15 is a view illustrating a noise generated in the first sustain pulse applied to the scan electrode or the sustain electrode in a sustain period; and

FIGS. 16a and 16b show sustain pulses of a sustain period in the driving waveform according to a method of driving the plasma display apparatus according to another embodiment of the present invention.

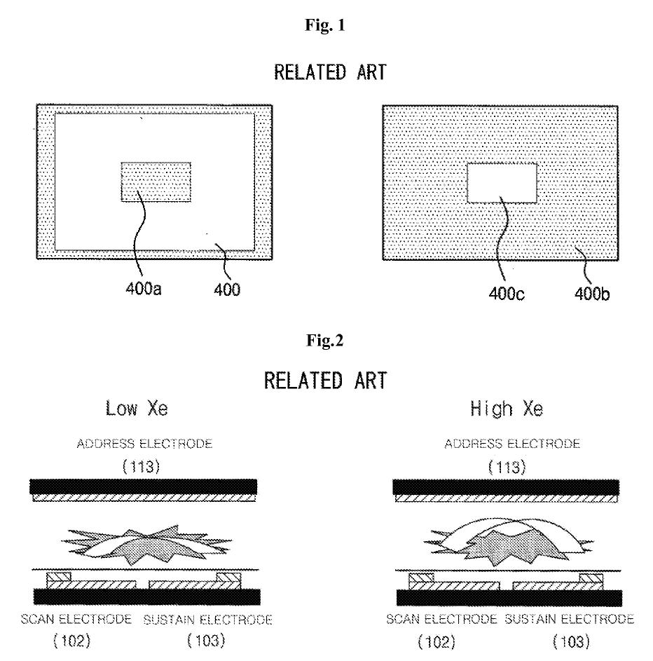

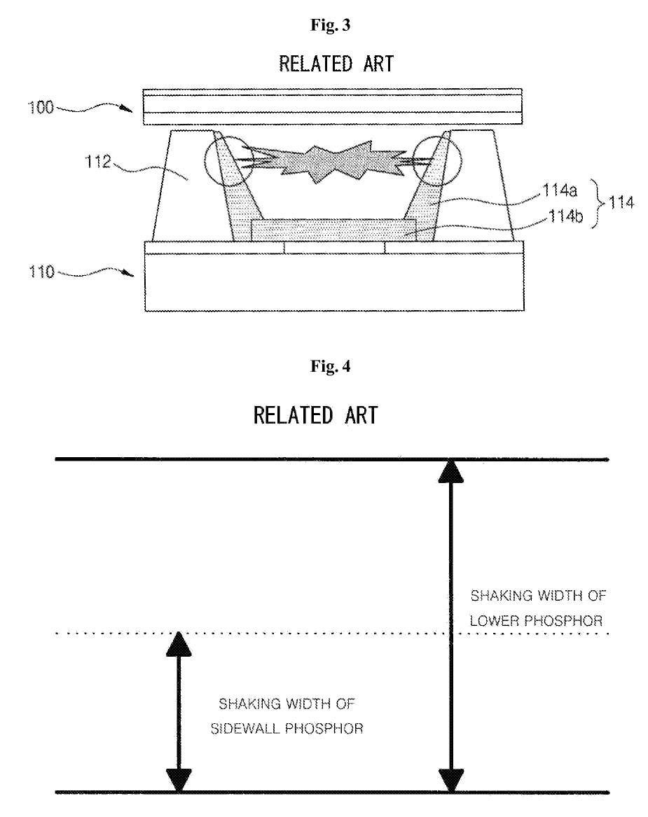

### DETAILED DESCRIPTION OF THE PREFERRED EMBODIMENT

Embodiments of the present invention will be described in a more detailed manner with reference to the drawings.

A plasma display apparatus according to an embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, at least one of the first sustain pulse applied to the scan electrode and the second sustain pulse applied to the sustain electrode has a falling (ER-Down) period and a rising (ER-Up) period that are different from each other, and the falling (ER-Down) period at the overlapped point of the sustain pulses is adjusted depending on the magnitude of a noise generated in a falling direction of the sustain pulse.

Preferably, the falling (ER-Down) period at the overlapped point of the sustain pulses is adjusted when the noise generated in the falling direction of the sustain pulse is within a range of less than 10V.

The falling (ER-Down) period at the overlapped point of the sustain pulses ranges from more than 400 ns to less than 700 ns.

The overlapped point of the sustain pulses is a point within a range of ±50 ns from a point of ½ (Vs/2) of a sustain voltage (Vs).

At the overlapped point of the sustain pulses, the falling (ER-Down) period and the rising (ER-Up) period of the sustain pulse are different from each other.

At the overlapped point, the falling (ER-Down) period of the sustain pulse is less than or equal to the rising (ER-Up) period of the sustain pulse.

The overlapped point is a point where the first sustain pulse applied to the scan electrode falls (ER-Down) and the second sustain pulse applied to the sustain electrode rises (ER-Up).

In the sustain pulse of which the rising (ER-Up) period and the falling (ER-Down) period are different from each other, as the falling (ER-Down) period increases, the rising (ER-Up) period decreases, and as the falling (ER-Down) period decreases, the rising (ER-Up) period increases.

In the sustain pulse of which the rising (ER-Up) period and the falling (ER-Down) period are different from each other, the rising (ER-Up) period ranges from more than 400 ns to less than 700 ns.

A plasma display apparatus according to another embodiment of the present invention comprises a plasma display panel comprising a scan electrode and a sustain electrode, a driver for driving the scan electrode and the sustain electrode and a sustain pulse controller for controlling the driver so that a first sustain pulse applied to the scan electrode and a second sustain pulse applied to the sustain electrode are overlapped with each other, and a falling (ER-Down) period at the overlapped point of the sustain pulses is adjusted to exceed a critical time length.

The critical time length is 600 ns.

The overlapped point of the sustain pulses is a point where the first sustain pulse applied to the scan electrode falls (ER-Down) and the second sustain pulse applied to the sustain electrode rises (ER-Up).

At the overlapped point, the falling (ER-Down) period of the sustain pulse is less than or equal to the rising (ER-Up) period of the sustain pulse.

The overlapped point is a point within a range of ±50 ns from a point of ½ (Vs/2) of a sustain voltage (Vs).

A plasma display apparatus according to further another embodiment of the present invention comprises a plasma display panel comprising a scan electrode and a sustain electrode, a driver for driving the scan electrode and the sustain electrode, and a sustain pulse controller for controlling the driver so that a first sustain pulse applied to the scan electrode and a second sustain pulse applied to the sustain electrode are overlapped with each other, and a falling (ER-Down) period running to the overlapped point of the sustain pulses is more than or equal to a falling (ER-Down) period running from the overlapped point of the sustain pulses.

The overlapped point of the sustain pulses is a point of less than ½ (Vs/2) of a sustain voltage (Vs).

At the overlapped point, the falling (ER-Down) period of the sustain pulse is less than or equal to the rising (ER-Up) period of the sustain pulse.

At the overlapped point, the falling (ER-Down) period of the sustain pulses ranges from more than 300 ns to less than 400 ns.

The overlapped point is a point within a range of ±50 ns from a point of ¼ (Vs/4) of a sustain voltage (Vs).

Detailed embodiments of the present invention will now be described hereinafter with reference to the accompanying drawings.

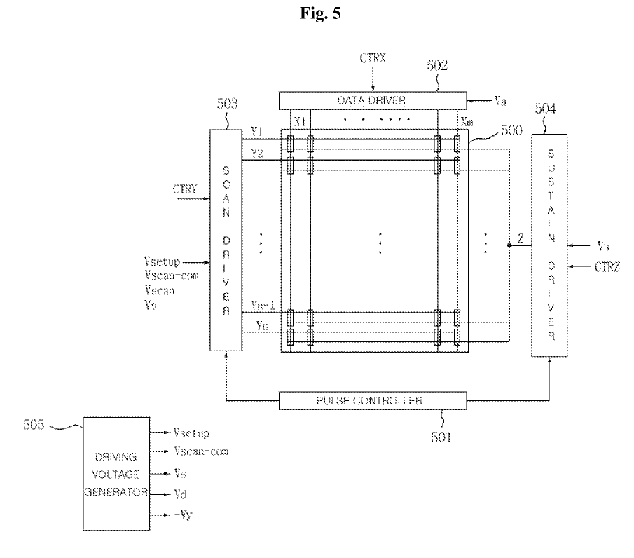

FIG. 5 is a view illustrating the construction of a plasma display apparatus according to an embodiment of the present invention.

As shown in FIG. 5, the plasma display apparatus according to an embodiment of the present invention comprises a plasma display panel 500 in which driving pulses are applied to address electrodes X1 to Xm, scan electrodes Y1 to Yn and a sustain electrode Z in a reset period, an address period and a sustain period, a data driver 502, a scan driver 503, a sustain driver 504, a sustain pulse controller 501 and a driving voltage generator 505. The plasma display panel 500 displays images consisting of frames by means of a combination of at least one or more sub-fields. The data driver 502 supplies data to the address electrodes X1 to Xm formed in the plasma display panel 500. The scan driver 503 drives the scan electrodes Y1 to Yn. The sustain driver 504 drives the sustain electrode Z, i.e., a common electrode. The sustain pulse controller 501 controls the scan driver 503 and the sustain driver 504 upon the driving of the plasma display panel 500 to adjust the supply of a reset pulse in the reset period, the supply of a scan pulse in the address period, and a voltage or a width of a sustain pulse in the sustain period. The driving voltage generator 505 supplies driving voltages necessary for the respective a driver 502, 503 and 504.

The data driver 502 is supplied with data, which have been subjected to inverse gamma correction, error diffusion, etc. by means of an inverse gamma correction circuit, an error diffusion circuit, etc., and then mapped to respective sub-fields by means of a sub-field mapping circuit. The data driver 902 samples and latches the data in response to a data timing control signal (CTRX) output from a timing controller (not shown) and supplies the data to the address electrodes X1 to Xm. The data driver 902 also supplies the address electrodes X1 to Xm with an erase pulse during an erase period.

The scan driver 503 supplies the reset pulse to the scan electrodes Y1 to Yn during the reset period and the scan pulse to the scan electrodes Y1 to Yn during the address period, under the control of the sustain pulse controller 501. The scan driver 503 also provides the sustain pulse to the scan electrodes Y1 to Yn during the sustain period and the erase pulse to the scan electrodes Y1 to Yn during the erase period, under the control of the pulse controller 501.

The sustain driver 504 supplies a predetermined bias voltage to the sustain electrodes Z during the address period under the control of the sustain pulse controller 501, and also alternately operates with the scan driver 503 during the sustain period, thus providing a sustain voltage (Vs) to the sustain electrodes Z. Furthermore, the sustain driver 504 provides the erase pulse to the sustain electrodes Z during the erase period.

The sustain pulse controller 501 supplies the respective a driver 502, 503 and 504 with predetermined control signals for controlling an operating timing and synchronization of the data driver 502, the scan driver 503 and the sustain driver 504 in the reset period, the address period, the sustain period and the erase period.

Specifically, unlike the conventional related art, the sustain pulse controller 501 according to an embodiment of the present invention can control the scan driver 503 and the sustain driver 504, so that the first sustain pulse applied to the scan electrodes and the second sustain pulse applied to the sustain electrodes are overlapped with each other, and at least one of the first sustain pulse applied to the scan electrodes and the second sustain pulse applied to the sustain electrodes has a falling (ER-Down) period and a rising (ER-Up) period that are different from each other, and the falling (ER-Down) period at the overlapped point of the sustain pulses is adjusted depending on the magnitude of a noise generated in a falling direction of the sustain pulse.

Meanwhile, the data timing control signal (CTRX) contains a sampling clock for sampling data, a latch control signal, and a switching control signal for controlling an on/off time of an energy recovery circuit (not shown) and a driving switch element (not shown). The scan control signal (CTRY) contains a switching control signal for controlling an on/off time of an energy recovery circuit (not shown) and a driving switch element (not shown) within the scan driver 503. The sustain control signal (CTRZ) contains a switching control signal for controlling an on/off time of an energy recovery circuit (not shown) and a driving switch element (not shown) within the sustain driver 504.

The driving voltage generator 505 generates a set-up voltage (Vsetup), a common scan voltage (Vscan-com), a scan voltage (−Vy), a sustain voltage (Vs), a data voltage (Vd) and the like. It is to be noted that these driving voltages may vary depending upon the composition of a discharge gas or the structure of a discharge cell.

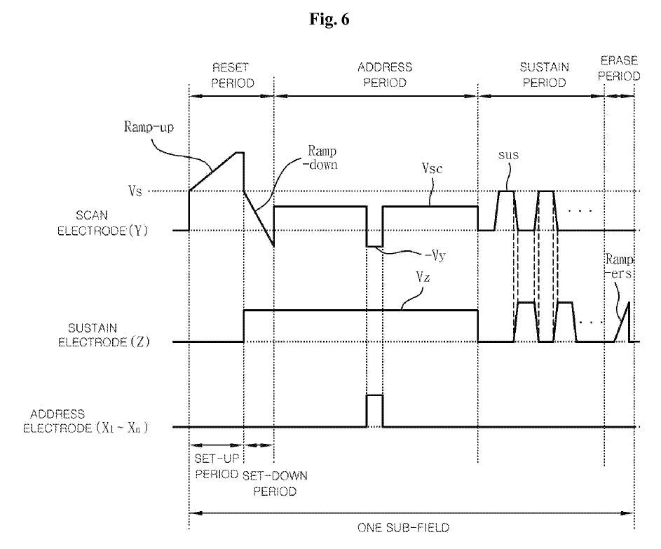

FIG. 6 is a view illustrating an example of a driving waveform according to a method of driving a plasma display apparatus according to an embodiment of the present invention.

As shown in FIG. 6, the plasma display apparatus according to an embodiment of the present invention is driven with each sub-field of one frame being divided into a reset period for initializing the entire cells, an address period for selecting a cell to be discharged, a sustain period for sustaining the discharge of a selected cell and an erase period for erasing wall charges within a discharged cell.

In a set-up period of the reset period, a ramp-up waveform (Ramp-up) is applied to the entire scan electrodes at the same time. The ramp-up waveform generates a weak dark discharge within the discharge cells of the entire screen. The set-up discharge also causes positive wall charges to be accumulated on the address electrodes and the sustain electrodes, and negative wall charges to be accumulated on the scan electrodes.

In a set-down period of the reset period, after the ramp-up waveform has been applied to the scan electrodes, a ramp-down waveform (Ramp-down), which falls from a positive voltage lower than a peak voltage of the ramp-up waveform to a predetermined voltage level lower than a ground (GND) level voltage, generates a weak erase discharge within the cells, thereby sufficiently erasing wall charges that have been excessively formed on the scan electrodes. The set-down discharge causes wall charges of the degree in which an address discharge can be stably generated to uniformly remain within the cells.

In the address period, while a negative scan pulse is sequentially applied to the scan electrodes, a positive data pulse is applied to the address electrodes in synchronization with the scan pulse. As a voltage difference between the scan pulse and the data pulse and a wall voltage generated in the reset period are added, an address discharge is generated within the discharge cell to which the data pulse is applied. Furthermore, wall charges of the degree in which a discharge can be generated when the sustain voltage is applied are formed within a cell selected by the address discharge. During the set-down period and the address period, the sustain electrodes Z are supplied with a positive voltage (Vz) such that an erroneous discharge is not generated between the sustain electrodes and the scan electrodes by reducing a voltage difference between the sustain electrodes and the scan electrodes.

In the sustain period, a sustain pulse (sus) is alternately applied to the scan electrodes and the sustain electrodes. As a wall voltage within the cells and the sustain pulse are added, a sustain discharge, i.e., a display discharge is generated between the scan electrodes and the sustain electrodes in cells selected by an address discharge whenever the sustain pulse is applied.

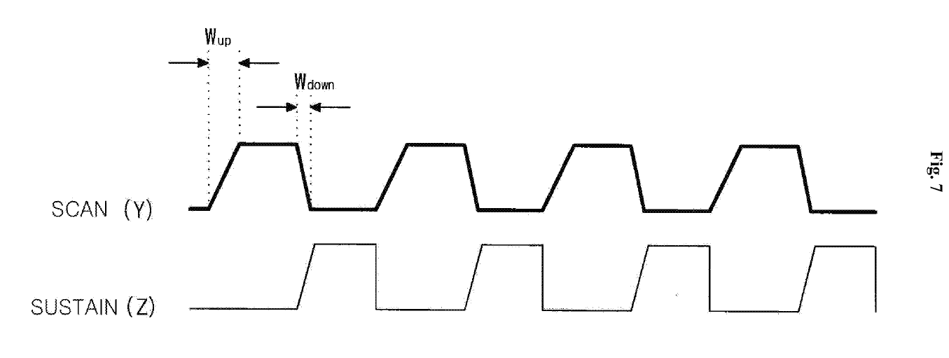

Specifically, unlike the conventional related art, the method of driving the plasma display apparatus according to an embodiment of the present invention is characterized in the sustain period. The sustain pulse applied in the sustain period will be described below in more detail with reference to FIG. 7.

FIG. 7 shows the sustain pulse of the sustain period in the driving waveform according to the method of driving the plasma display apparatus according to an embodiment of the present invention.

As shown in FIG. 7, in the driving waveform according to the method of driving the plasma display apparatus according to an embodiment of the present invention, the first sustain pulse applied to the scan electrode Y and the second sustain pulse applied to the sustain electrode Z in the sustain period are overlapped with each other.

At this time, in at least one of the first sustain pulse applied to the scan electrode (Y) and the second sustain pulse applied to the sustain electrode (Z), a rising (ER-Up) period where its slope is more than 0 (>0) differs from a falling (ER-Down) period where its slope is less than 0 (<0). In this case, the first sustain pulse applied to the scan electrode Y and the second sustain pulse applied to the sustain electrode Z in the sustain period are overlapped with each other at a time point where the slope of the first sustain pulse applied to the scan electrode is less than 0, i.e., the first sustain pulse applied to the scan electrode falls (ER-Down), and the slope of the second sustain pulse applied to the sustain electrode is more than 0, i.e., the second sustain pulse applied to the sustain electrode rises (ER-Up).

It has been shown in FIG. 7 that the sustain pulses are overlapped with each other in a period where the first sustain pulse applied to the scan electrode Y falls (ER-Down) and the second sustain pulse applied to the sustain electrode Z rises (ER-Up). However, in the present invention, the sustain pulses may be overlapped with each other in a period where the first sustain pulse applied to the scan electrode Y rises (ER-Up) and the second sustain pulse applied to the sustain electrode Z falls (ER-Down), or the sustain pulses may be overlapped with each other in a period where the first sustain pulse applied to the scan electrode Y rises (ER-Up) or fall (ER-Down) and the second sustain pulse applied to the sustain electrode Z correspondingly falls (ER-Down) or rises (ER-Up).

In this case, the first sustain pulse applied to the scan electrode Y gradually rises or falls at a predetermined slope. Furthermore, the second sustain pulse applied to the sustain electrode Z also gradually rises or falls at a predetermined slope. That is, as shown in FIG. 7, the sustain pulse has a rising (ER-Up) period or a falling (ER-Down) period having a predetermined length.

This is to minimize an interaction with the address electrode by reducing an instant potential difference during the sustain discharge. Therefore, a phenomenon in which a discharge is attracted toward the address electrode during the sustain discharge is reduced. It is thus possible to stably maintain discharge efficiency of each phosphor and also to reduce generation of an afterimage, i.e., a bright afterimage.

Furthermore, as the first sustain pulse applied to the scan electrode Y is overlapped with the second sustain pulse applied to the sustain electrode Z as described above, a reduction in sustain margin, which is generated as the falling (ER-Down) period or the rising (ER-Up) period of the first sustain pulse applied to the scan electrode Y or the sustain electrode Z is lengthened, can be prevented.

For example, if the first sustain pulse applied to the scan electrode Y or the second sustain pulse applied to the sustain electrode Z gradually rises or falls at a predetermined slope upon rising or falling as described above, generation of a bright afterimage can be prohibited, but sustain margin becomes worse since a time where one sustain pulse is applied is lengthened. Therefore, as the first sustain pulse applied to the scan electrode Y and the second sustain pulse applied to the sustain electrode Z are overlapped with each other as described above, such sustain margin can be prevented from becoming worse.

Furthermore, the reason why the first sustain pulse applied to the scan electrode Y and the second sustain pulse applied to the sustain electrode Z are overlapped with each other is that a sustain pulse of a low voltage is applied to the sustain electrode Z by using priming particles of a self discharge, which are generated when the first sustain pulse applied to the scan electrode Y falls (ER-Down).

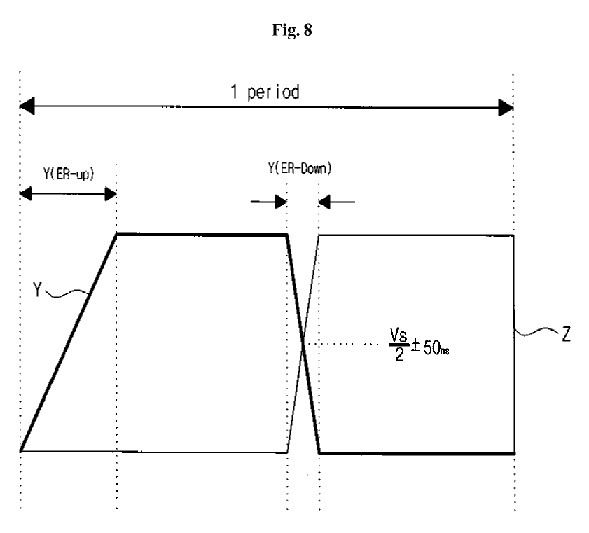

Furthermore, the first sustain pulse applied to the scan electrode Y is overlapped with the second sustain pulse applied to the sustain electrode Z during the falling of the first sustain pulse applied to the scan electrode Y, the falling (ER-Up) period and the rising (ER-Up) period of the first sustain pulse applied to the scan electrode Y are different from each other, which will be described in more detail with reference to FIG. 8.

FIG. 8 is a view illustrating, in more detail, a portion where sustain pulses of a scan electrode and a sustain electrode are overlapped with each other.

As shown in FIG. 8, a time point where the first sustain pulse applied to the scan electrode Y and the second sustain pulse applied to the sustain electrode Z, in the sustain period, are overlapped with each other is a point within a range of ±50 ns from the point of ½ (Vs/2) of the sustain voltage (Vs).

For example, assuming that a time point where the first sustain pulse applied to the scan electrode Y or the sustain electrode Z becomes ½ (Vs/2) of the sustain voltage (Vs) is 200 ns, a point where the first sustain pulse applied to the scan electrode Y and the second sustain pulse applied to the sustain electrode Z in the above-described sustain period are overlapped with each other is a point ranging from a time point, which is 50 ns prior to the time point of ½ (Vs/2) of the sustain voltage (Vs), i.e., a time point of 150 ns to a time point, which is 50 ns subsequent to the time point of ½ (Vs/2) of the sustain voltage (Vs), i.e., a time point of 250 ns.

Therefore, a sustain discharge can be further stabilized. Furthermore, after the rise of a discharge voltage, which is generated as the rising (ER-Up) time of the sustain pulse of the scan electrode is lengthened, the rise of the discharge voltage does not occur entirely because a sustain discharge is generated even if even a low voltage is applied to the sustain electrode. The rise of the discharge voltage does not occur although the sustain pulses are overlapped with each other while the rising (ER-Up) time of the scan electrode (Y) and the sustain electrode (Z) is changed.

In the driving waveform according to an embodiment of the present invention, in at least one of the first sustain pulse applied to the scan electrode (Y) and the second sustain pulse applied to the sustain electrode (Z), a rising (ER-Up) period where its slope is more than 0 (>0) differs from a falling (ER-Down) period where its slope is less than 0 (<0).

That is, a period from the time point when at least one of the first sustain pulse applied to the scan electrode (Y) and the second sustain pulse applied to the sustain electrode (Z) starts to rise to the time point when the sustain pulse reaches the sustain voltage (Vs) differs from a period from the time point when at least one of the first sustain pulse applied to the scan electrode (Y) and the second sustain pulse applied to the sustain electrode (Z) starts to fall to the time point when the sustain pulse reaches a ground level (GND).

For example, as shown in FIG. 8, assuming that of the first sustain pulse applied to the scan electrode Y and the second sustain pulse applied to the sustain electrode (Z) within one period of the sustain pulse, the sustain pulse of which a falling (ER-Down) period and a rising (ER-Up) period differ from each other is the first sustain pulse applied to the scan electrode Y, when a period where the slope of the first sustain pulse applied to the scan electrode Y is more than 0 (>0), i.e., a period from the time point when the first sustain pulse applied to the scan electrode Y starts to rise to the time point when the sustain pulse reaches the sustain voltage (Vs) is the rising (ER-Up) period, and a period where the slope of the first sustain pulse applied to the scan electrode Y is less than 0 (<0) is the falling (ER-Down) period, the relationship of \textcircled{1} rising (ER-Up)≦falling (ER-Down) or \textcircled{2} falling (ER-Down)≦rising (ER-Up) is established. That is, as the falling period of the first sustain pulse applied to the scan electrode Y increases, the rising period of the sustain pulse decreases. Alternatively, as the falling period of the first sustain pulse applied to the scan electrode Y decreases, the rising period of the sustain pulse increases.

At this time, in case of \textcircled{1} rising (ER-Up)≦falling (ER-Down), the rising period of the first sustain pulse applied to the scan electrode Y is lengthened to thereby improve a bight afterimage. At this time, the margin of the sustain period that decreases due to the lengthening of the rising period of the sustain pulse to improve the bright afterimage is compensated due to the relative shortening of the falling period of the first sustain pulse applied to the scan electrode Y, thereby preventing the margin of the sustain period from being degraded. Similarly to \textcircled{1} rising (ER-Up)≦falling (ER-Down), in case of the above-mentioned \textcircled{2} falling (ER-Down)≦rising (ER-Up), the bright afterimage is also improved and the margin of the sustain period is prevented from being degraded.

In this case, the falling (ER-Down) period of the sustain pulses applied to the scan electrode Y ranges from more than 400 ns to less than 700 ns in consideration of the margin of the sustain period.

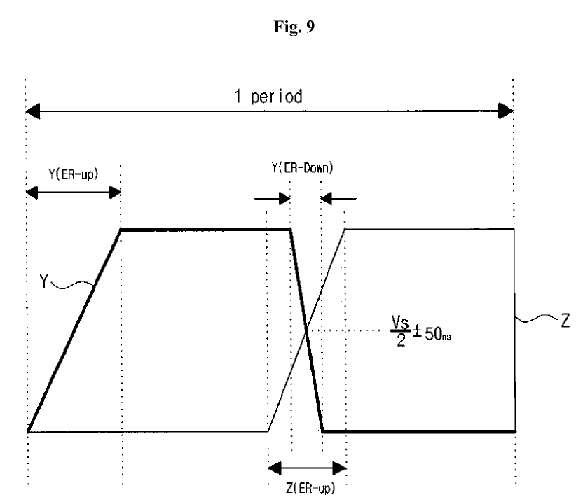

Furthermore, in the driving waveform according to an embodiment of the present invention, a falling (ER-Down) period of a falling sustain pulse and a rising (ER-Up) period of a rising sustain pulse are set to be different from each other, at a point where a first sustain pulse applied to the scan electrode Y and a second sustain pulse applied to the sustain electrode Z are overlapped with each other. The driving waveform in this case will be described with reference to FIG. 9.

As shown in FIG. 9, in the driving waveform according to an embodiment of the present invention, a falling (ER-Down) period of a sustain pulse that falls and a rising (ER-Up) period of a sustain pulse that rises are set to be different from each other, at a point where a first sustain pulse applied to the scan electrode Y and a second sustain pulse applied to the sustain electrode Z are overlapped with each other. In this case, the falling (ER-Down) period of the falling sustain pulse is preferably set to be less than or equal to the rising (ER-Up) period of the rising sustain pulse, at the point where the first sustain pulse applied to the scan electrode Y and the second sustain pulse applied to the sustain electrode Z are overlapped with each other. That is, the relationship of falling (ER-Down)≦rising (ER-Up) is established at the overlapped point of the sustain pulses.

In this case, the falling (ER-Down) period of the falling sustain pulse at the overlapped point of the sustain pulses is adjusted depending on the magnitude of a noise generated in the falling sustain pulse.

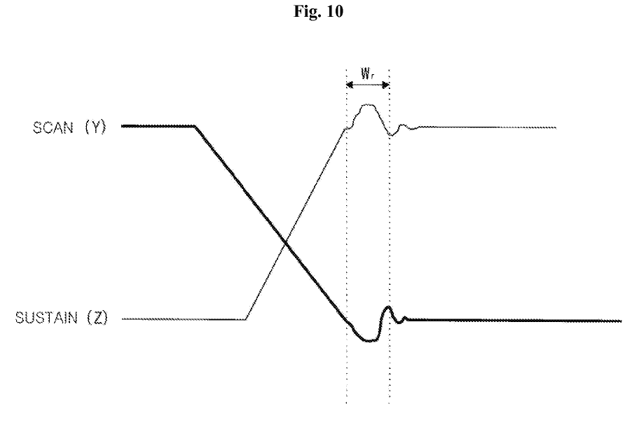

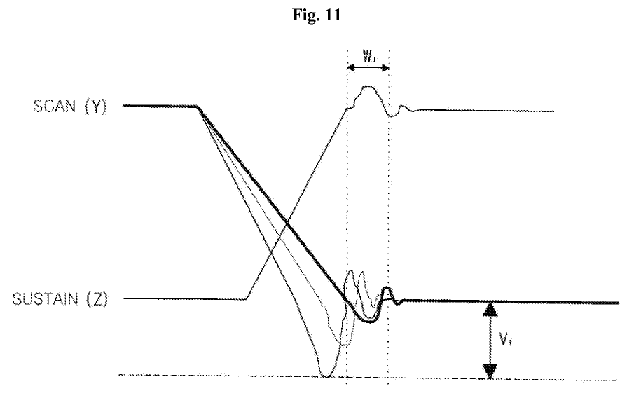

The noise generated in the falling sustain pulse at the overlapped point of the sustain pulses as described above may cause electrical damage to the elements for the plasma display panel. Accordingly, the falling (ER-Down) period of the falling sustain pulse at the overlapped point of the sustain pulses is adjusted in consideration of such a noise, which will be described below with reference to FIG. 10.

FIG. 10 is a view illustrating a noise generated in the scan electrode or the sustain electrode at the overlapped point of the sustain pulses applied to the scan electrode and the sustain electrode.

As shown in FIG. 10, a noise of a predetermined magnitude is generated in the scan electrode (Y) or the sustain electrode (Z) at the overlapped point of the sustain pulses. Assuming that a period where such a noise is generated is a ripple period, a noise of a predetermined magnitude is generated at the end point of a falling (ER-Down) period of the sustain pulse that falls at the ripple period in the direction where the sustain pulse falls. Also, a noise of a predetermined magnitude is generated at a rising (ER-Up) end point of the sustain pulse that rises at the ripple period in the direction where the sustain pulse rises.

Such a noise further increases as the falling (ER-Down) period of the falling sustain pulse or the rising (ER-Up) period of the rising sustain pulse is shortened. In this case, the noise that increases as the falling (ER-Down) period of the sustain pulse is shortened will be described below with reference to FIG. 11.

FIG. 11 is a view illustrating a noise increasing as a falling (ER-Down) period of the sustain pulse is shortened at the overlapped point of the sustain pulses applied to the scan electrode and the sustain electrode.

As shown in FIG. 11, as the falling (ER-Down) period of the sustain pulses applied to the scan electrode (Y), i.e., a period where the sustain pulse drops from the sustain voltage (Vs) to the ground level (GND) is shortened, the magnitude of the noise generated in the falling direction of the sustain pulse increases. At this time, a noise generated in the opposite direction to the falling direction of the sustain pulse also increases. Assuming that the magnitude of the noise generated in the falling direction of the sustain pulse as described above is set as Vr, if Vr exceeds a predetermined voltage, electrical damage is caused to the elements for the plasma display panel. In this case, the falling (ER-Down) period of the first sustain pulse applied to the scan electrode is adjusted when the magnitude Vr of the noise is within a range of less than 10V.

The falling (ER-Down) period of the first sustain pulse applied to the scan electrode is adjusted within a range from more than 400 ns to less than 700 ns when the magnitude Vr of the noise is within a range of less than 10V.

That is, the falling (ER-Down) period of the sustain pulse ranges from more than 400 ns to less than 700 ns, at a point where the first sustain pulse applied to the scan electrode Y and the second sustain pulse applied to the sustain electrode Z are overlapped with each other. Further, in the first sustain pulse applied to the scan electrode Y and the second sustain pulse applied to the sustain electrode (Z), the sustain pulse of which a falling (ER-Down) period and a rising (ER-Up) period differ from each other has the rising (ER-Up) period ranging from more than 400 ns to less than 700 ns.

In addition, in the first sustain pulse applied to the scan electrode Y and the second sustain pulse applied to the sustain electrode (Z), the sustain pulse of which a falling (ER-Down) period and a rising (ER-Up) period differ from each other has the rising (ER-Up) period ranging from more than 400 ns to less than 700 ns.

In this case, as described above with reference to FIG. 9, at the overlapped point of the sustain pulses, the falling (ER-Down) period of the sustain pulse is less than or equal to the rising (ER-Up) period of the sustain pulse. Thus, the fact that at the overlapped point of the sustain pulses, the falling (ER-Down) period of the sustain pulse is adjusted within a range from more than 400 ns to less than 700 ns means that the falling (ER-Down) period of the sustain pulse is adjusted within a range from more than 400 ns to less than 700 ns while being less than, but not equal to the rising (ER-Up) period of the sustain pulse.

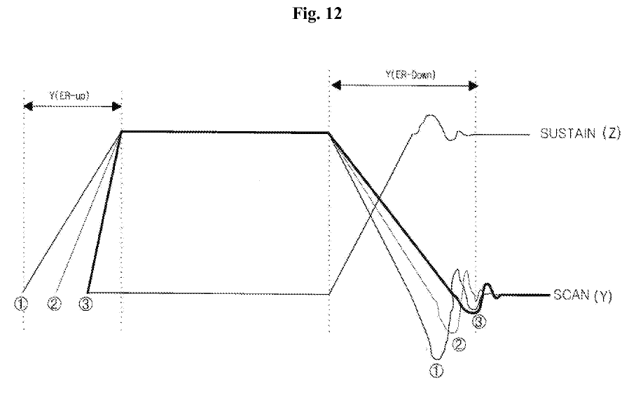

In order to prevent electrical damage from being caused to the elements for the plasma display panel as described above, it is necessary that both the falling (ER-Down) period and the rising (ER-Up) period of the first sustain pulse applied to the scan electrode Y or the second sustain pulse applied to the sustain electrode (Z) should be adjusted. The falling (ER-Down) period and the rising (ER-Up) period of the first sustain pulse applied to the scan electrode Y or the sustain electrode (Z) will be described below with reference to FIG. 12.

FIG. 12 is a view illustrating an example of determination of a falling (ER-Down) period or a rising (ER-Up) period of the first sustain pulse applied to the scan electrode or the sustain electrode.

As shown in FIG. 12, the falling (ER-Down) period or the rising (ER-Up) period of the first sustain pulse applied to the scan electrode (Y) or the sustain electrode (Z) is determined in consideration of the magnitude of a noise generated in the falling direction of the sustain pulse at the end point of a falling (ER-Down) period of the first sustain pulse applied to the scan electrode in the sustain period.

In this case, as described above, the falling (ER-Down) period of the first sustain pulse applied to the scan electrode (Y) is preferably adjusted when the magnitude of the noise generated in the falling (ER-Down) period of the first sustain pulse applied to the scan electrode is within a range of less than 10V.

Furthermore, as the falling (ER-Down) period of the first sustain pulse applied to the scan electrode (Y) increases, the rising (ER-Up) period of the first sustain pulse applied to the scan electrode (Y) decreases. For example, in case of a sustain pulse \textcircled{1}, the sustain pulse \textcircled{1} has the rising (ER-Up) period that is relatively long as compared to the rising (ER-Up) periods of other sustain pulses as shown in FIG. 12. Thus, in the falling (ER-Down) period of the sustain pulse \textcircled{1}, the slope of the sustain pulse \textcircled{1} falls more steeply than the slopes of other sustain pulses.

On the contrary, a sustain pulse \textcircled{3} has the rising (ER-Up) period that is relatively short as compared to the rising (ER-Up) periods of other sustain pulses as shown in FIG. 12. Thus, in the falling (ER-Down) period of the sustain pulse \textcircled{3}, the slope of the sustain pulse \textcircled{3} falls more gently than the slopes of other sustain pulses.

Here, in case of the sustain pulse \textcircled{1}, the magnitude of a noise generated at the end point of the falling (ER-Down) period of the sustain pulse \textcircled{1} in the falling direction of the sustain pulse \textcircled{1} is relatively great as compared to the magnitudes of noises generated in case of the other sustain pulses as shown in FIG. 12. At this time, as the rising (ER-Up) period of the sustain pulse \textcircled{1} increases further, the falling (ER-Down) period thereof decreases further, at which case, the noise generated in the falling direction of the sustain pulse \textcircled{1} increases accordingly.

A plasma display apparatus according to another embodiment of the present invention will be described below.

First, the plasma display apparatus according to another embodiment is identical to the plasma display apparatus according to one embodiment of the present invention as described above with reference to FIG. 5 except the sustain pulse controller 501, and hence the detailed description of the remaining constitutional elements except the sustain pulse controller 501 will be replaced with the above-mentioned description of FIG. 5.

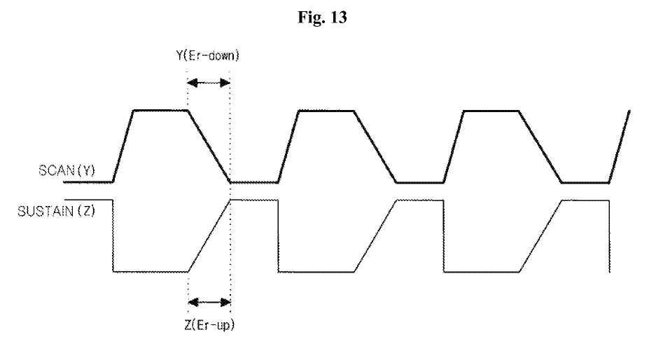

The sustain pulse controller 501 controls the scan driver 503 and the sustain driver 504 so that a first sustain pulse applied to the scan electrode and a second sustain pulse applied to the sustain electrode are overlapped with each other, and a falling (ER-Down) period running to the overlapped point of the sustain pulses is more than or equal to a falling (ER-Down) period running from the overlapped point of the sustain pulses, which will be described below with reference to FIG. 13.

FIG. 13 shows a sustain pulse of a sustain period in the driving waveform according to a method of driving the plasma display apparatus according to another embodiment of the present invention.

As shown in FIG. 13, in the plasma display apparatus according to another embodiment of the present invention, a first sustain pulse applied to the scan electrode (Y) and a second sustain pulse applied to the sustain electrode (Z) in a sustain period are overlapped with each other.

At this time, a falling (ER-Down) period of the sustain pulse at the overlapped point of the sustain pulses applied to the scan electrode (Y) and the sustain electrode (Z) is set to exceed a critical time length.

The critical time length of a falling (ER-Down) period of the sustain pulse at the overlapped point of the sustain pulses applied to the scan electrode (Y) and the sustain electrode (Z) is 600 ns. That is, a predetermined falling (ER-Down) period of the sustain pulse at the overlapped point of the sustain pulses has a time length of more than 600 ns. In this case, the sustain pulse of which the falling (ER-Down) period at the overlapped point of the sustain pulses has a time length of more than 600 ns is the first sustain pulse applied to the scan electrode (Y) or the second sustain pulse applied to the sustain electrode (Z). That is, the sustain pulse that falls at the overlapped point of the sustain pulses may be the first sustain pulse applied to the scan electrode (Y) or the second sustain pulse applied to the sustain electrode (Z).

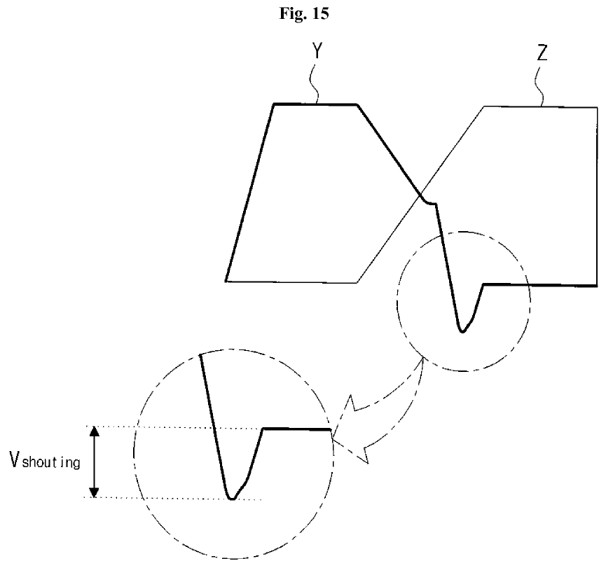

As such, the reason why a predetermined falling (ER-Down) period of the sustain pulse at the overlapped point of the sustain pulses is set to have a time length of more than 600 ns is that sufficient margin of a sustain discharge is secured and the generation of a noise is reduced. Such a noise will be described in more detail later with reference to FIG. 15.

The first sustain pulse applied to the scan electrode (Y) and the second sustain pulse applied to the sustain electrode (Z) are overlapped with each other at a point where the slope of the first sustain pulse applied to the scan electrode (Y) is less than 0, i.e., the first sustain pulse applied to the scan electrode (Y) falls (ER-Down), and where the slope of the second sustain pulse applied to the sustain electrode (Z) is more than 0, i.e., the second sustain pulse applied to the sustain electrode (Z) rises (ER-Up). Accordingly, the falling (ER-Down) period of the first sustain pulse applied to the scan electrode (Y) at the overlapped point of the sustain pulses has a time length of more than 600 ns as described above.

In addition, the first sustain pulse applied to the scan electrode (Y) has a predetermined slope upon the rising or falling of the sustain pulse. Also, the second sustain pulse applied to the sustain electrode (Z) has a predetermined slope upon the rising of the sustain pulse. This is to reduce an instant potential difference during the sustain discharge so as to minimize the interaction between the sustain electrode and the address electrode.

Therefore, a phenomenon in which a discharge is attracted toward the address electrode during the sustain discharge can be reduced. It is thus possible to stably maintain discharge efficiency of each phosphor and also to reduce generation of an afterimage, i.e., a bright afterimage.

Furthermore, at the overlapped point of the first sustain pulse applied to the scan electrode (Y) and the second sustain pulse applied to the sustain electrode (Z), the falling (ER-Down) period of the sustain pulse preferably is less than or equal to the rising (ER-Up) period of the sustain pulse.

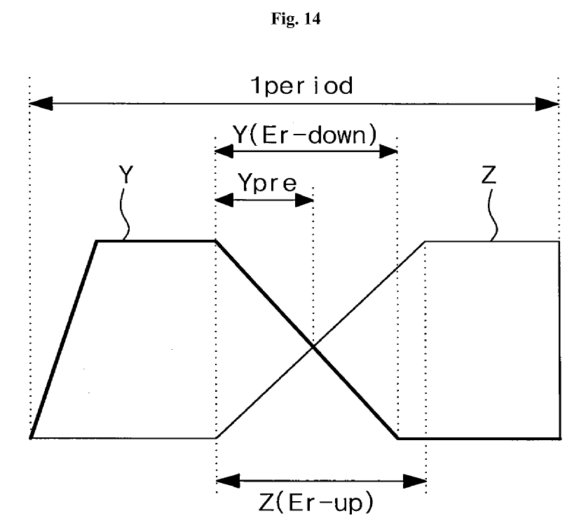

For example, as described above, in the case where the overlapped point of the first sustain pulse applied to the scan electrode (Y) and the second sustain pulse applied to the sustain electrode (Z) is a point where the slope of the first sustain pulse applied to the scan electrode (Y) is less than 0, i.e., the first sustain pulse applied to the scan electrode (Y) falls (ER-Down) and where the slope of the second sustain pulse applied to the sustain electrode (Z) is more than 0, i.e., the second sustain pulse applied to the sustain electrode (Z) rises (ER-Up), the falling (ER-Down) period of the first sustain pulse applied to the scan electrode (Y) is less than or equal to the rising (ER-Up) period of the second sustain pulse applied to the sustain electrode (Z) at the overlapped point of the sustain pulses applied to the scan electrode (Y) and the sustain electrode (Z), which will be described below in more detail with reference to FIG. 14.

FIG. 14 is a view illustrating, in more detail, a portion where sustain pulses of a scan electrode and a sustain electrode are overlapped with each other.

As shown in FIG. 14, the first sustain pulse applied to the scan electrode (Y) and the second sustain pulse applied to the sustain electrode (Z) are overlapped with each other at a point where the slope of the first sustain pulse applied to the scan electrode (Y) in the sustain period is less than 0, i.e., the first sustain pulse applied to the scan electrode (Y) falls, and where the slope of the second sustain pulse applied to the sustain electrode (Z) in the sustain period is more than 0, i.e., the second sustain pulse applied to the sustain electrode (Z) rises.

In this case, the reason why the first sustain pulse applied to the scan electrode (Y) and the second sustain pulse applied to the sustain electrode (Z) are overlapped with each other is that a sustain pulse of a low voltage is applied to the sustain electrode (Z) by using priming particles of a self discharge, which are generated when the first sustain pulse applied to the scan electrode (Y) falls (ER-Down).

In this manner, the first sustain pulse applied to the scan electrode (Y) and the second sustain pulse applied to the sustain electrode (Z) are overlapped with each other, so that after the rise of a discharge voltage, which is generated as the rising (ER-Up) time of the sustain pulse of the scan electrode is lengthened, the rise of the discharge voltage does not occur entirely because a sustain discharge is generated even if even a low voltage is applied to the sustain electrode. The rise of the discharge voltage does not occur although the sustain pulses are overlapped with each other while the rising (ER-Up) time of the scan electrode (Y) and the sustain electrode (Z) is changed.

As described above, in the driving waveform according to one embodiment of the present invention, the falling (ER-Down) period of the first sustain pulse applied to the scan electrode (Y) is less than or equal to the rising (ER-Up) period of the second sustain pulse applied to the sustain electrode (Z) at the overlapped point of the sustain pulses applied to the scan electrode (Y) and the sustain electrode (Z).

That is, at the overlapped point of the sustain pulses applied to the scan electrode (Y) and the sustain electrode (Z), a period from the time point when the first sustain pulse applied to the scan electrode (Y) starts to fall to the time point when the sustain pulse reaches a ground level (GND) is less than or equal to a period from the time point when the second sustain pulse applied to the sustain electrode (Z) starts to rise to the time point when the sustain pulse reaches the sustain voltage (Vs).

For example, assuming that at the overlapped point of the sustain pulses applied to the scan electrode (Y) and the sustain electrode (Z) within one period of the sustain pulse, a period where the slope of the first sustain pulse applied to the scan electrode (Y) in the sustain period is less than 0, i.e., a period from the time point when the first sustain pulse applied to the scan electrode (Y) starts to fall to the time point when the sustain pulse reaches a ground level (GND) is Y falling (ER-Down), and a period where the slope of the second sustain pulse applied to the sustain electrode (Z) is more than 0, i.e., a period from the time point when the second sustain pulse applied to the sustain electrode (Z) starts to rise to the time point when the sustain pulse reaches the sustain voltage (Vs) is Z rising (ER-Up), the relationship of Y falling (ER-Down)≦Z rising (ER-Up) is established.

As described above, a predetermined falling (ER-Down) period of the sustain pulse at the overlapped point of the sustain pulses has a time length of more than 600 ns. Also, the overlapped point of the first sustain pulse applied to the scan electrode (Y) and the second sustain pulse applied to the sustain electrode (Z) has been set as a point where the first sustain pulse applied to the scan electrode (Y) falls (ER-Down) and the second sustain pulse applied to the sustain electrode (Z) rises (ER-Up).

Therefore, the falling (ER-Down) period of the first sustain pulse applied to the scan electrode (Y) at the overlapped point of the sustain pulses may have a time length of more than 600 ns. Further, preferably, at the overlapped point of the first sustain pulse applied to the scan electrode (Y) and the second sustain pulse applied to the sustain electrode (Z), the rising (ER-Up) period of the second sustain pulse applied to the sustain electrode (Z) has a time length of more than 600 ns while being more than the falling (ER-Down) period of the first sustain pulse applied to the scan electrode (Y).

As described above, the reason why the falling (ER-Down) period of the sustain pulse at the overlapped point of the sustain pulses is set to have a time length of more than 600 ns is that sufficient margin of a sustain discharge is secured and the generation of a noise is reduced.

In the meantime, the overlapped point of the first sustain pulse applied to the scan electrode (Y) and the second sustain pulse applied to the sustain electrode (Z) is a point within a range of ±50 ns from a point of ½ (Vs/2) of a sustain voltage (Vs).

As such, when the overlapped point of the first sustain pulse applied to the scan electrode (Y) and the second sustain pulse applied to the sustain electrode (Z) is set as a point within a range of ±50 ns from a point of ½ (Vs/2) of a sustain voltage (Vs), a sustain discharge occurs stably only at a period within a range of ±50 ns from a point of ½ of the falling (ER-Down) period of the sustain pulse at the overlapped point, and the sustain discharge occurs unstably or does not occur at periods beyond a range of ±50 ns from a point of ½ of the falling (ER-Down) period of the sustain pulse. Resultantly, a sufficient sustain discharge does not occur.

In order to address and resolve the problem of such a sustain discharge, preferably, the falling (ER-Down) period where the sustain pulse falling at the overlapped point reaches the overlapped point has a time length of more than 300 ns. That is, a period from the time point when the first sustain pulse applied to the scan electrode (Y) starts to fall to the time point when the first sustain pulse applied to the scan electrode (Y) and the second sustain pulse applied to the sustain electrode (Z) are overlapped with each other, i.e., Y(pre) has a time length of more than 300 ns as shown in FIG. 14.

As described above, in order to reduce the generation of a noise, it is basically required that at the overlapped point of the sustain pulses, the falling (ER-Down) period of a predetermined sustain pulse, i.e., the falling sustain pulse should be set to have a time length of more than 600 ns, and when the overlapped point of the sustain pulses is a point within a range of ±50 ns from a point of ½ (Vs/2) of a sustain voltage (Vs), a period from the time point when the falling (ER-Down) sustain pulse starts to fall to the overlapped time point should be set to have a time length of more than 300 ns.

The noise generated in the sustain pulse may cause electrical damage to the elements for the plasma display panel. Such a noise will be described below with reference to FIG. 15.

FIG. 15 is a view illustrating a noise generated in the first sustain pulse applied to the scan electrode or the sustain electrode in a sustain period. An example of the case where the sustain pulses are overlapped with each other at a point where the first sustain pulse applied to the scan electrode (Y) falls (ER-Down) and the second sustain pulse applied to the sustain electrode (Z) rises (ER-Up) will be described below

As shown in FIG. 15, at the overlapped point of the sustain pulses applied to the scan electrode (Y) and the sustain electrode (Z) in the sustain period, a noise of a predetermined magnitude is generated in the scan electrode (Y) or the sustain electrode (Z). Assuming that the magnitude of the noise is V_{shouting}, this noise is generated in the falling direction of the first sustain pulse applied to the scan electrode (Y) or the sustain electrode (Z).

The magnitude V_{shouting} of the noise increases as the falling (ER-Down) period of the first sustain pulse applied to the scan electrode (Y) or the sustain electrode (Z) decreases. When the magnitude V_{shouting} of the noise exceeds a predetermined voltage valve, electrical damage may be caused to the elements for the plasma display panel.

For this reason, at the overlapped point of the sustain pulses, the falling (ER-Down) period of the falling sustain pulse is set to have a time length of more than 600 ns, and when the overlapped point of the sustain pulses is a point within a range of ±50 ns from a point of ½ (Vs/2) of a sustain voltage (Vs), a period from the time point when the falling sustain pulse starts to fall to the overlapped time point is set to have a time length of more than 300 ns.

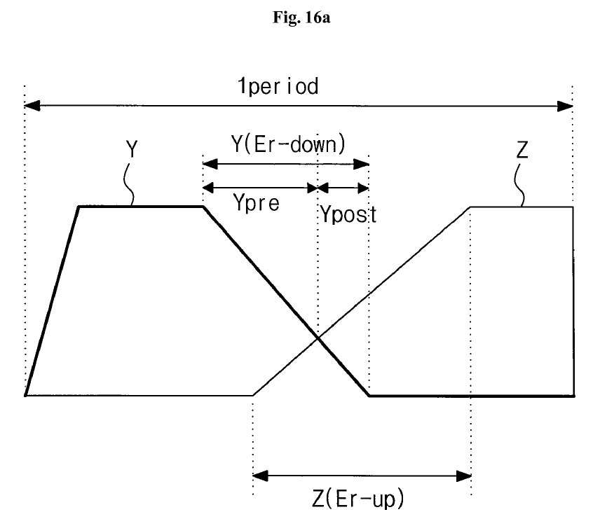

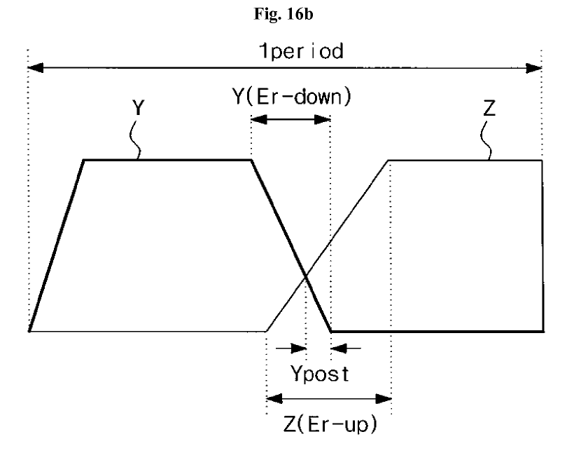

In the meantime, in the driving method of the plasma display apparatus according to another embodiment of the present invention as described above, the falling (ER-Down) period of the sustain pulse falling at the overlapped point of the sustain pulses in the sustain period is adjusted to reduce the generation of the noise. Alternatively, the overlapped point of the sustain pulses may be adjusted to reduce the generation of the noise. This driving method will be described below with reference to FIGS. 16a and 16b.

FIGS. 16a and 16b show sustain pulses of a sustain period in the driving waveform according to a method of driving the plasma display apparatus according to another embodiment of the present invention.

First, as shown in FIG. 16a, in the plasma display apparatus according to another embodiment of the present invention, a first sustain pulse applied to the scan electrode (Y) and a second sustain pulse applied to the sustain electrode (Z) in a sustain period are overlapped with each other, and a falling (ER-Down) period from the time point when the first sustain pulse applied to the scan electrode (Y) starts to fall to the overlapped time point is more than or equal to a falling (ER-Down) period from the overlapped time point to the time point when the sustain pulse reaches a ground level (GND).

In this case, the overlapped point of the sustain pulses applied to the scan electrode (Y) and the sustain electrode (Z) is adjusted to reduce a noise (V_{shouting}) generated in the falling direction of the first sustain pulse applied to the scan electrode (Y) or the sustain electrode (Z) at the overlapped point of the sustain pulses as shown in FIG. 15.

More preferably, the overlapped point of the sustain pulses applied to the scan electrode (Y) and the sustain electrode (Z) is adjusted to a point of less than ½ (Vs/2) of a sustain voltage (Vs).

As described above, the reason why the overlapped point of the sustain pulses is set to a point of less than ½ (Vs/2) of the sustain voltage (Vs) is that sufficient margin of a sustain discharge is secured and the generation of a noise is reduced.

In this case, preferably, the first sustain pulse applied to the scan electrode Y and the second sustain pulse applied to the sustain electrode Z in the sustain period are overlapped with each other at a time point where the slope of the first sustain pulse applied to the scan electrode is less than 0, i.e., the first sustain pulse applied to the scan electrode falls (ER-Down), and the slope of the second sustain pulse applied to the sustain electrode is more than 0, i.e., the second sustain pulse applied to the sustain electrode rises (ER-Up).

Therefore, as shown in FIG. 16a, if in the falling (ER-Down) period of the first sustain pulse applied to the scan electrode (Y), a period from the time point when the first sustain pulse applied to the scan electrode (Y) starts to fall to the time point when the sustain pulses applied to the scan electrode (Y) and the sustain electrode (Z) are overlapped with each other is Yₚᵣₑ, and a period from the overlapped time point of the sustain pulses to the time point when the first sustain pulse applied to the scan electrode (Y) reaches a ground level (GND) is Yₚₒₛₜ, the relationship of Y_{post≦}Yₚᵣₑ is established.

In the meantime, an energy recovery circuit for recovering unavailable energy of the plasma display panel, i.e., an ER circuit is connected to the scan electrode (Y) and sustain electrode (Z), respectively. Upon the recovering of the energy, for example, upon the recovering of the energy at an end of the scan electrode (Y), e.g., during the falling (ER-Down) of the sustain pulse, when the sustain pulse starts to rise (ER-Up) at an end of the sustain electrode (Z), the scan electrode (Y) recovers the energy while the sustain electrode (Z) supplies the energy.

Therefore, the supply of the energy to the sustain electrode (Z) causes the recovery of the energy toward the scan electrode (Y) to be interrupted, so that upon the overlapping of the sustain pulses the recovery of the energy (ER) is obstructed as described above. In order to reduce the interruption of ER, the time length of Yₚᵣₑ is set to be more than or equal to that of Yₚₒₛₜ, so that upon the recovery of the energy (ER) the interruption of the ER is reduced to increase the efficiency of ER.

In addition, as in the plasma display apparatus according to another embodiment of the present invention aforementioned with reference to FIG. 14, the first sustain pulse applied to the scan electrode (Y) has a predetermined slope during its rising or falling. Furthermore, the second sustain pulse applied to the sustain electrode (Z) also rises at a predetermined slope.

This is to minimize an interaction with the address electrode by reducing an instant potential difference during the sustain discharge. Therefore, a phenomenon in which a discharge is attracted toward the address electrode during the sustain discharge is reduced. It is thus possible to stably maintain discharge efficiency of each phosphor and also to reduce generation of an afterimage, i.e., a bright afterimage.

Moreover, as described above, the first sustain pulse applied to the scan electrode (Y) and the second sustain pulse applied to the sustain electrode (Z) are overlapped with each other at a point where the slope of the first sustain pulse applied to the scan electrode (Y) in the sustain period is less than 0, i.e., the first sustain pulse applied to the scan electrode (Y) falls, and where the slope of the second sustain pulse applied to the sustain electrode (Z) in the sustain period is more than 0, i.e., the second sustain pulse applied to the sustain electrode (Z) rises.

In this case, the reason why the first sustain pulse applied to the scan electrode Y and the second sustain pulse applied to the sustain electrode Z are overlapped with each other is that a sustain pulse of a low voltage is applied to the sustain electrode Z by using priming particles of a self discharge, which are generated when the first sustain pulse applied to the scan electrode Y falls (ER-Down) as in another embodiment of the present invention aforementioned with reference to FIG. 14.

In this manner, the first sustain pulse applied to the scan electrode (Y) and the second sustain pulse applied to the sustain electrode (Z) are overlapped with each other, so that after the rise of a discharge voltage, which is generated as the rising (ER-Up) time of the sustain pulse of the scan electrode is lengthened, the rise of the discharge voltage does not occur entirely because a sustain discharge is generated even if even a low voltage is applied to the sustain electrode. The rise of the discharge voltage does not occur although the sustain pulses are overlapped with each other while the rising (ER-Up) time of the scan electrode (Y) and the sustain electrode (Z) is changed.

Furthermore, as shown in FIG. 9, in the plasma display apparatus according to another embodiment of the present invention, the falling (ER-Down) period of the falling sustain pulse is set to be less than or equal to the rising (ER-Up) period of the rising sustain pulse, at the point where the first sustain pulse applied to the scan electrode Y and the second sustain pulse applied to the sustain electrode Z are overlapped with each other.

For example, the falling (ER-Down) period of the first sustain pulse applied to the scan electrode (Y) is less than or equal to the rising (ER-Up) period of the rising second sustain pulse applied to the sustain electrode (Z), at the point where the first sustain pulse applied to the scan electrode Y and the second sustain pulse applied to the sustain electrode Z are overlapped with each other.

That is, at the overlapped point of the sustain pulses applied to the scan electrode (Y) and the sustain electrode (Z), a period from the time point when the first sustain pulse applied to the scan electrode (Y) starts to fall to the time point when the sustain pulse reaches a ground level (GND) is less than or equal to a period from the time point when the second sustain pulse applied to the sustain electrode (Z) starts to rise to the time point when the sustain pulse reaches the sustain voltage (Vs).

For example, assuming that at the overlapped point of the sustain pulses applied to the scan electrode (Y) and the sustain electrode (Z) within one period of the sustain pulse, a period where the slope of the first sustain pulse applied to the scan electrode (Y) in the sustain period is less than 0, i.e., a period from the time point when the first sustain pulse applied to the scan electrode (Y) starts to fall to the time point when the sustain pulse reaches a ground level (GND) is Y falling (ER-Down), and a period where the slope of the second sustain pulse applied to the sustain electrode (Z) is more than 0, i.e., a period from the time point when the second sustain pulse applied to the sustain electrode (Z) starts to rise to the time point when the sustain pulse reaches the sustain voltage (Vs) is Z rising (ER-Up), the relationship of Y falling (ER-Down)≦Z rising (ER-Up) is established.

Under the condition aforementioned, at the overlapped point of the sustain pulses applied the scan electrode (Y) and the sustain electrode (Z), the falling (ER-Down) period of the sustain pulse, e.g., the Y falling (ER-Down) period as shown in FIG. 16b is preferably adjusted within a range of more than 300 ns to less than 400 ns.

As described above, the reason why the falling (ER-Down) period of the sustain pulse is adjusted such a range is that since the overlapped point of the sustain pulses has been set to be a point of less than ½ (Vs/2) of the sustain voltage (Vs), although the falling (ER-Down) period of the sustain pulse at the overlapped point of the sustain pulses is adjusted within a range of more than 300 ns to less than 400 ns, the noise generated in the falling direction of the sustain pulse upon the falling (ER-Down) of the sustain pulse, i.e., the noise V_{shouting} as shown in FIG. 15 is reduced.

Furthermore, in the case where at the overlapped point of the sustain pulses applied the scan electrode (Y) and the sustain electrode (Z), the falling (ER-Down) period of the sustain pulse, is adjusted within a range of more than 300 ns to less than 400 ns, the overlapped point of the first sustain pulse applied to the scan electrode (Y) and the second sustain pulse applied to the sustain electrode (Z) is a point within a range of ±50 ns from a point of ¼ (Vs/4) of the sustain voltage (Vs).

In another embodiment of the present invention, when a period from a time point when the first sustain pulse applied to the scan electrode (Y) is overlapped with the sustain pulses applied to the sustain electrode (Z) to a time point when the first sustain pulse applied to the scan electrode (Y) reaches the ground level (GND) is lengthened, the noise generated in the falling direction of the first sustain pulse applied to the scan electrode (Y), i.e., the noise V_{shouting} as shown in FIG. 15 further increases.

Therefore, it is necessary that a period from a time point when the first sustain pulse applied to the scan electrode (Y) is overlapped with the sustain pulses applied to the sustain electrode (Z) to a time point when the first sustain pulse applied to the scan electrode (Y) reaches the ground level (GND) should be adjusted.

In this case, assuming that a period from a time point when the first sustain pulse applied to the scan electrode (Y) is overlapped with the sustain pulses applied to the sustain electrode (Z) to a time point when the first sustain pulse applied to the scan electrode (Y) reaches the ground level (GND) is Yₚₒₛₜ, the period Yₚₒₛₜ is preferably adjusted to less than 200 ns.

Therefore, the present invention has advantages in that it improves the sustain pulse of the sustain period so that generation of a bright afterimage can be reduced, and a degradation of a sustain margin and an electrical damage of the plasma display panel due to a noise are prevented.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
a driver for driving the scan electrode and the sustain electrode; and
a sustain pulse controller for controlling the driver so that a first sustain pulse applied to the scan electrode and a second sustain pulse applied to the sustain electrode are overlapped with each other, at least one of the first sustain pulse applied to the scan electrode and the second sustain pulse applied to the sustain electrode has a falling (ER-Up) period and a rising (ER-Up) period that are different from each other, and the falling (ER-Down) period at the overlapped point of the sustain pulses is adjusted depending on the magnitude of a noise generated in a falling direction of the sustain pulse.

2. The plasma display apparatus as claimed in claim 1, wherein the falling (ER-Down) period at the overlapped point of the sustain pulses is adjusted when the noise generated in the falling direction of the sustain pulse is within a range of less than 10V.

3. The plasma display apparatus as claimed in claim 2, wherein the falling (ER-Down) period at the overlapped point of the sustain pulses ranges from more than 400 ns to less than 700 ns.

4. The plasma display apparatus as claimed in claim 3, wherein the overlapped point of the sustain pulses is a point within a range of ±50 ns from a point of ½ (Vs/2) of a sustain voltage (Vs).

5. The plasma display apparatus as claimed in claim 4, wherein at the overlapped point of the sustain pulses, the falling (ER-Down) period and the rising (ER-Up) period of the sustain pulse are different from each other.

6. The plasma display apparatus as claimed in claim 5, wherein at the overlapped point, the falling (ER-Down) period of the sustain pulse is less than or equal to the rising (ER-Up) period of the sustain pulse.

7. The plasma display apparatus as claimed in claim 6, wherein the overlapped point is a point where the first sustain pulse applied to the scan electrode falls (ER-Down) and the second sustain pulse applied to the sustain electrode rises (ER-Up).

8. The plasma display apparatus as claimed in claim 3, wherein in the sustain pulse of which the rising (ER-Up) period and the falling (ER-Down) period are different from each other, as the falling (ER-Down) period increases, the rising (ER-Up) period decreases, and as the falling (ER-Down) period decreases, the rising (ER-Up) period increases.

9. The plasma display apparatus as claimed in claim 8, wherein in the sustain pulse of which the rising (ER-Up) period and the falling (ER-Down) period are different from each other, the rising (ER-Up) period ranges from more than 400 ns to less than 700 ns.

10. A plasma display apparatus comprising:
a plasma display panel comprising a scan electrode and a sustain electrode;
a driver for driving the scan electrode and the sustain electrode; and
a sustain pulse controller for controlling the driver so that a first sustain pulse applied to the scan electrode and a second sustain pulse applied to the sustain electrode are overlapped with each other, and a falling (ER-Down) period at the overlapped point of the sustain pulses is adjusted to exceed a critical time length.

11. The plasma display apparatus as claimed in claim 10, wherein the critical time length is 600 ns.

12. The plasma display apparatus as claimed in claim 11, wherein the overlapped point of the sustain pulses is a point where the first sustain pulse applied to the scan electrode falls (ER-Down) and the second sustain pulse applied to the sustain electrode rises (ER-Up).

13. The plasma display apparatus as claimed in claim 12, wherein at the overlapped point, the falling (ER-Down) period of the sustain pulse is less than or equal to the rising (ER-Up) period of the sustain pulse.

14. The plasma display apparatus as claimed in claim 13, wherein the overlapped point is a point within a range of ±50 ns from a point of ½ (Vs/2) of a sustain voltage (Vs).

15. A plasma display apparatus comprising:
a plasma display panel comprising a scan electrode and a sustain electrode;
a driver for driving the scan electrode and the sustain electrode; and
a sustain pulse controller for controlling the driver so that a first sustain pulse applied to the scan electrode and a second sustain pulse applied to the sustain electrode are overlapped with each other, and a falling (ER-Down) period running to the overlapped point of the sustain pulses is more than or equal to a falling (ER-Down) period running from the overlapped point of the sustain pulses.

16. The plasma display apparatus as claimed in claim 15, wherein the overlapped point of the sustain pulses is a point of less than ½ (Vs/2) of a sustain voltage (Vs).

17. The plasma display apparatus as claimed in claim 16, wherein at the overlapped point, the falling (ER-Down) period of the sustain pulse is less than or equal to the rising (ER-Up) period of the sustain pulse.

18. The plasma display apparatus as claimed in claim 17, wherein at the overlapped point, the falling (ER-Down) period of the sustain pulses ranges from more than 300 ns to less than 400 ns.

19. The plasma display apparatus as claimed in claim 18, wherein the overlapped point is a point within a range of ±50 ns from a point of ¼ (Vs/4) of a sustain voltage (Vs).
